(19) United States
(12) Patent Application Publication
(10) Pub. No.: US 2011/0220841 A1
(43) Pub. Date: Sep. 15, 2011

(54) THERMAL AND/OR ELECTRICAL CONDUCTIVITY CONTROL IN SUSPENSIONS

(75) Inventors: Ruiting Zheng, Beijing (CN); Jinwei Gao, Zhangjiajie (CN); Gang Chen, Carlisle, MA (US)

(73) Assignee: Massachusetts Institute of Technology, Cambridge, MA (US)

(21) Appl. No.: 12/720,382

(22) Filed: Mar. 9, 2010

(51) Int. Cl. C09K 5/00; F25C 1/00

(52) U.S. Cl. 252/71; 62/66

(57) ABSTRACT

Articles, systems, and methods involving the control of thermal and/or electrical conductivity in suspensions are generally described.

### GOVERNMENT SPONSORSHIP

This invention was sponsored by NSF Grant No. CBET-0506830. The government has certain rights in the invention.

### FIELD OF INVENTION

The present invention relates generally to articles, systems, and methods involving the control of thermal and/or electrical conductivity in suspensions.

### BACKGROUND

The ability to control the transfer of heat and/or electricity can be useful in many applications such as, for example, heating and cooling systems, electricity distribution, sensing, and the like. Recent research has been done on high thermal and electrical conductivity fluids. Such fluids can be made, for example, by suspending materials with relatively high thermal and/or electrical conductivities in fluid with a lower thermal and/or electrical conductivity. Generally, however, once a material has been suspended in the fluid, the thermal and electrical conductivity of the fluid suspension is fixed. There exists a demand for systems in which the thermal and/or electrical conductivity of a suspension can be altered without adding additional materials to the suspension.

### SUMMARY OF THE INVENTION

Articles, systems, and methods related to the control of electrical and/or thermal conductivity in suspensions are provided.

In one set of embodiments, a method is described. The method can comprise, in some cases, providing a fluid comprising particles, and freezing the fluid to form a polycrystalline solid comprising crystal grains and grain boundaries. In some embodiments, a majority of the particles have maximum cross-sectional dimensions of less than about 10 microns. The particles can have, in some cases, a thermal conductivity of at least about 5 W/mK and/or an electrical conductivity of at least about 10 S m⁻¹, in at least one direction, as measured at 25° C. In some instances, during the freezing step, at least a portion of the particles within the fluid migrate toward regions in which grain boundaries are formed such that the concentration of the particles at the grain boundaries is greater than the concentration of the particles within the crystal grains.

In some cases, the method can comprise providing a suspension comprising a suspension medium in a first phase and particles within the suspension medium, applying a thermal gradient and/or an electrical potential across the suspension, and allowing the suspension medium to undergo a phase change from the first phase to a second phase such that the thermal conductivity and/or the electrical conductivity of the suspension changes.

Other advantages and novel features of the present invention will become apparent from the following detailed description of various non-limiting embodiments of the invention.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1C include schematic illustrations of a phase change within a suspension, according to one set of embodiments;

FIG. 2 includes an exemplary schematic illustration of the microstructure of a graphite particle;

FIG. 3 includes an optical image at 30 times magnification of graphite particles before they are exfoliated, according to one set of embodiments;

FIG. 4 includes a schematic illustration of a particle, according to one set of embodiments;

FIGS. 5A-5E include (A) an exemplary scanning electron microscope (SEM) image of graphite flakes; (B) an exemplary transmission electron microscopy (TEM) image of a graphite flake; (C) an exemplary high resolution TEM (HRTEM) image of the selected area a in FIG. 5B; (D) an exemplary optical microscope image of the microstructure of a 0.2% (V/V) graphite/hexadecane suspension; and (E) an exemplary optical image of a 0.2% v/v graphite/hexadecane suspension after standing for three months;

FIGS. 6A-6G include (A) an exemplary plot of the electrical conductivities of suspensions with various particle volume fractions as a function of temperature; (B) an exemplary plot of the variance ratio of the electrical conductivity of a suspension as a function of particle volume fraction; (C) an exemplary plot of the thermal conductivities of suspensions with various particle volume fractions as a function of temperature; (D) an exemplary plot of the variance ratio of the electrical conductivity of a suspension as a function of particle volume fraction; (E) an exemplary optical microscope image of a 0.05% graphite/hexadecane suspension; (F) an exemplary image of a frozen graphite/hexadecane suspension; and (G) an exemplary image of the microstructure of a re-melted graphite suspension;

FIG. 7 includes a schematic diagram of an experimental setup used to measure contact resistance, according to one set of embodiments; and

FIGS. 8A-8C include (A) an exemplary schematic diagrams illustrating the variation in contact area between particles; (B) an exemplary plot of electrical resistivity as a function of temperature; and (C) an exemplary pressure distribution map of frozen hexadecane.

### DETAILED DESCRIPTION

Articles, systems, and methods involving the control of thermal and/or electrical conductivity in suspensions are generally described. In some embodiments, particles can be added to a fluid to produce a suspension with an altered thermal and/or electrical conductivity (e.g., particles can increase the thermal and/or electrical conductivity). The thermal and/or electrical conductivity of the suspension can be further altered by subjecting the suspension to a change in phase (e.g., freezing or melting). For example, the thermal and/or electrical conductivity can be further increased by freezing the suspension. In some embodiments, the fluid containing the suspended particles can be frozen to form a polycrystalline solid comprising crystal grains and grain boundaries. Upon freezing the fluid, the particles may migrate toward regions in which grain boundaries are formed such that the concentration of the particles at the grain boundaries is greater than the concentration of the particles within the crystal grains. The concentration of particles at the grain boundaries can lead to the formation of a network of particles, as described further below.

In some cases, a thermal gradient and/or an electrical potential can be established across the suspension. In such cases, the suspension may conduct a relatively large amount of heat and/or electrical current when the suspension is in a first phase (e.g., a solid composite) and a relatively small amount of heat and/or electrical current when the suspension is in a second phase (e.g., a liquid suspension). Such embodiments may be useful, for example, in the production and/or operation of a thermistor, which can be used, for example, as a current limiter, temperature sensor, self-resetting overcurrent protector, self-regulating heating element), and the like.

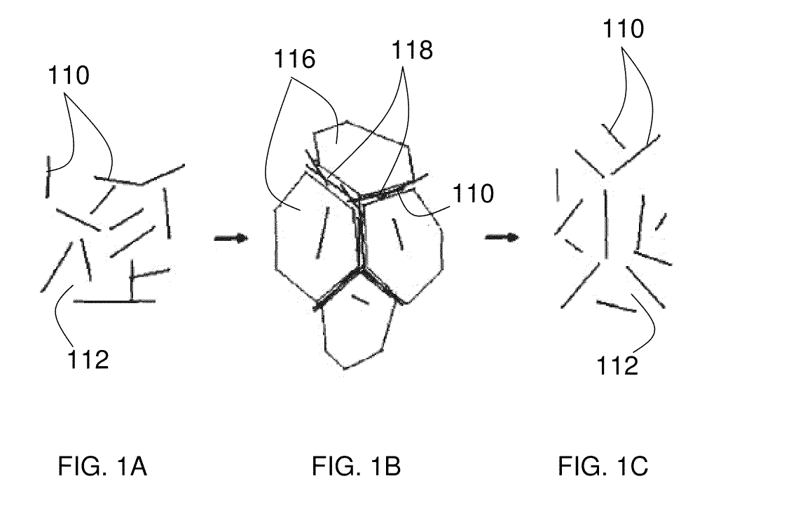

FIGS. 1A-1C include schematic illustrations outlining the phase change in a suspension of particles, according to one set of embodiments. In FIG. 1A, particles 110 are suspended in fluid 112, which forms the suspension medium. As shown in FIG. 1A, the particles are substantially evenly dispersed within the suspension medium. In other embodiments, the particles may form a plurality of clusters when the suspension medium is a liquid. As an example, in some embodiments, the particles may form a network (e.g., resulting from previous freeze and thaw cycles) when the suspension is in the liquid phase.

In some embodiments, the suspension medium can undergo one or more phase changes (e.g., freezing, melting, etc.) which can alter the thermal and/or electrical conductivity of the suspension. For example, in some cases, a liquid suspension (i.e., a suspension containing a liquid suspension medium) can be frozen to form a solid composite (i.e., a suspension containing particles suspended in a solid suspension medium). It should be understood that the term “suspension” is used generally herein to refer to both a liquid suspension as well as a solid composite. FIG. 1B includes a schematic illustration of the suspension in FIG. 1A after it has been frozen. Upon freezing, fluid 112 forms a polycrystalline solid suspension medium, including crystal grains 116 and grain boundaries 118, thus forming a solid composite. During the freezing process, the particles can migrate toward regions in which grain boundaries are formed such that the concentration of the particles at the grain boundaries is greater than the concentration of the particles within the crystal grains. The migration of particles toward the grain boundaries may result in the formation of a network of particles (e.g., an interconnected network of particles). As shown in FIG. 1B, particles 110 have migrated toward grain boundaries 118 of the polycrystalline solid to form a network.

The solid composite (i.e., the frozen suspension) can exhibit, in some instances, a large thermal and/or electrical conductivity, relative to the thermal and/or electrical conductivity of the liquid suspension. In some embodiments, the thermal conductivity of the solid composite can be at least about 2 times, at least about 3 times, or between about 2 times and about 5 times greater than the thermal conductivity of the liquid suspension. In some cases, the electrical conductivity of the solid composite can be at least about 2 times, at least about 5 times, at least about 10 times, at least about 50 times, at least about 100 times, at least about 1000 times, between about 2 times and about 1000 times, between about 2 times and about 100 times, between about 5 times and about 1000 times, or between about 10 times and about 1000 times greater than the electrical conductivity of the liquid suspension. Not wishing to be bound by any particular theory, the relatively large thermal and/or electrical conductivity of the solid composite may be due to the concentration of particles (and internal pressure) at grain boundaries, which can lead to the formation of a network of particles through which heat and/or electricity can be efficiently transported. The thermal conductivity of a fluid or suspension can be measured using the transient hot-wire method developed by Nagasaka and Nagashima in J Phys E: Scientific Instruments, Vol. 14, pp. 1435-1440 (1981).

In some embodiments, a solid composite can be melted to form a liquid suspension. FIG. 1C includes a schematic illustration of the solid composite in FIG. 1B after it has been melted. In FIG. 1C, particles 110 have been dispersed within a liquid suspension medium (i.e., fluid 112). As shown in FIG. 1C, the particles are substantially evenly dispersed. However, in some embodiments, the particles may remain formed in a network to at least some degree after the suspension medium has been melted. In some cases, the particles may form a plurality of clusters in which particles are agglomerated. In still other cases, the particles may form an network even after the suspension medium has been melted.

Melting a solid composite may reduce the thermal and/or electrical conductivity of the resulting liquid suspension, relative to the thermal and electrical conductivity of the solid composite. In some embodiments, the thermal conductivity of the re-melted liquid suspension can be at least about 2 times, at least about 3 times, at least about 5 times, between about 2 times and about 10 times, or between about 2 times and about 5 times smaller than the thermal conductivity of the solid composite. In some cases, the electrical conductivity of the re-melted liquid suspension can be at least about 2 times, at least about 5 times, at least about 10 times, at least about 50 times, at least about 100 times, at least about 1000 times, between about 2 times and about 1000 times, between about 2 times and about 100 times, between about 5 times and about 1000 times, or between about 10 times and about 1000 times, smaller than the electrical conductivity of the solid composite. Not wishing to be bound by any particular theory, the reduction in thermal and/or electrical conductivity of the suspension upon melting may be due to the dissociation of the particles within the suspension medium.

In some cases, the re-melted liquid suspension may have a higher thermal and/or electrical conductivity than that of the liquid suspension prior to solidification. For example, in some cases a first liquid suspension with a first electrical conductivity and a first thermal conductivity can be frozen to form a solid composite. Subsequently, the solid composite can be melted to form a second liquid suspension with a second electrical conductivity and/or a second thermal conductivity that is higher than the first electrical conductivity and/or first thermal conductivity. Not wishing to be bound by any particular theory, the electrical and/or thermal conductivity of the second liquid suspension (i.e., the re-melted suspension) may be larger than that of the first liquid suspension because some of the particles may remain agglomerated (e.g., forming a network of particles) after the solid composite is melted. In some cases, the second liquid suspension (i.e., the re-melted suspension) may have an electrical and/or thermal conductivity that is at least about 2 times greater, at least about 5 times greater, or between about 2 and about 10 times greater than that of the first liquid suspension.

The suspension media described herein can undergo any number of phase changes (e.g., freeze/thaw cycles). In some embodiments, the suspension can exhibit a relatively consistent change in thermal and/or electrical conductivity over a relatively large number of freeze/thaw cycles (e.g., after the initial freeze/thaw cycle). For example, in some cases, the change in thermal and/or electrical conductivity between the solid and liquid phase suspensions can vary by less than about 20%, less than about 10%, less than about 5%, less than about 1%, or can be substantially the same over at least 2, at least 5, at least 10, at least 100, at least 1000, or more freeze/thaw cycles. It should be understood that a single freeze/thaw cycle includes the transformation of the suspension medium from liquid to solid back to liquid.

The particles described herein can be made of any suitable material. For example, in some cases, the particles can be formed of a metal, which can be in a substantially pure form or in the form of an alloy. Metal particles can be, in some instances, in the form of nanoscale metal particles. The metal particles can comprise, for example, metal nanotubes, metal nanowires, metal nanodisks, metal nanosheets, or metal nanofilaments. The use of metal particles can be advantageous, in some embodiments, due to their relatively high thermal and electrical conductivities. In some embodiments, the particles can include metal oxides.

The particles can include, in some embodiments, crystalline materials that exhibit basal cleavage. Basal cleavage is a phenomenon known to those of ordinary skill in the art, and refers to a behavior in which cleavage of a crystalline material occurs parallel to the base of a crystal. Examples of suitable materials include, but are not limited to, mica (e.g., biotite, muscovite, phlogopite, lepidolite, margarite, glauconite, etc.), clay minerals (e.g., kaolinite, illite, smectite, montmorillonite, vermiculite, talc, palygorskite, pyrophyllite, etc.), among others.

In some embodiments, carbon-based particles can be used. In some cases, the carbon-based particles can comprise a fused network of aromatic rings wherein the particle comprises primarily carbon atoms. A carbon-based particle can comprise a fused network of at least about 10, at least about 50, at least about 100, at least about 1000, or at least about 10,000 aromatic rings. In some embodiments, the carbon-based particles may include a relatively high amount of carbon (e.g., at least about 95 wt %, at least 99 wt %, or at least 99.9 wt %), the carbon percentage measured exclusive of any functional groups that might be attached to the particles. Carbon-based particles may optionally comprise a border at which the fused network terminates. For example, a sheet of graphene comprises a planar carbon-containing molecule comprising a border at which the fused network terminates, while a carbon nanotube comprises a nonplanar carbon-based nanostructure with borders at either end. In some cases, the border may be substituted with hydrogen atoms. In some cases, the border may be substituted with groups comprising oxygen atoms (e.g., hydroxyl). Examples of carbon-based particles include, but are not limited to, graphene sheets, graphite particles, carbon nanotubes, carbon nanowires, carbon nanodisks, carbon nanosheets, and carbon nanofilaments. The use of carbon-based particles can be advantageous, in some embodiments, due to their relatively high thermal and electrical conductivities.

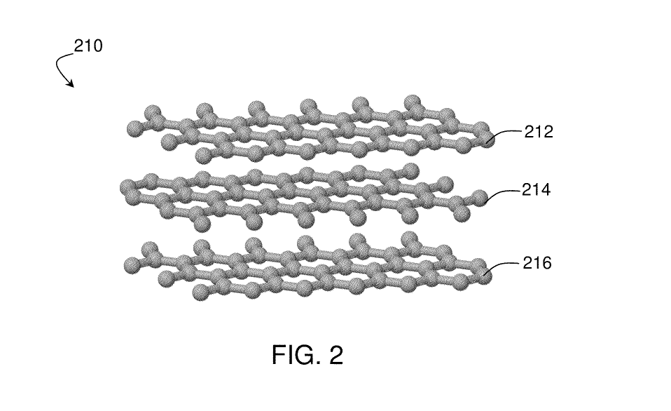

In some embodiments, the particles in the suspension may be graphite particles. FIG. 2 includes a schematic illustration of the microstructure of a graphite particle 210 that can be used in association with the embodiments described herein. Generally, the graphite particle structure comprises a plurality of layers (212, 214, and 216) of graphene. The layers of graphene comprise carbon atoms arranged in a hexagonal lattice. Adjacent graphene layers are typically attracted to each other via van der Waals forces, although covalent bonds may be present between one or more sheets in some cases. In some embodiments, a surface of a graphene layer can be oxidized, which can, in some cases, render at least a portion of the graphite particle hydrophilic. For example, in some cases, the graphite particle can be rendered substantially completely hydrophilic, or the graphite particle can be rendered amphiphilic.

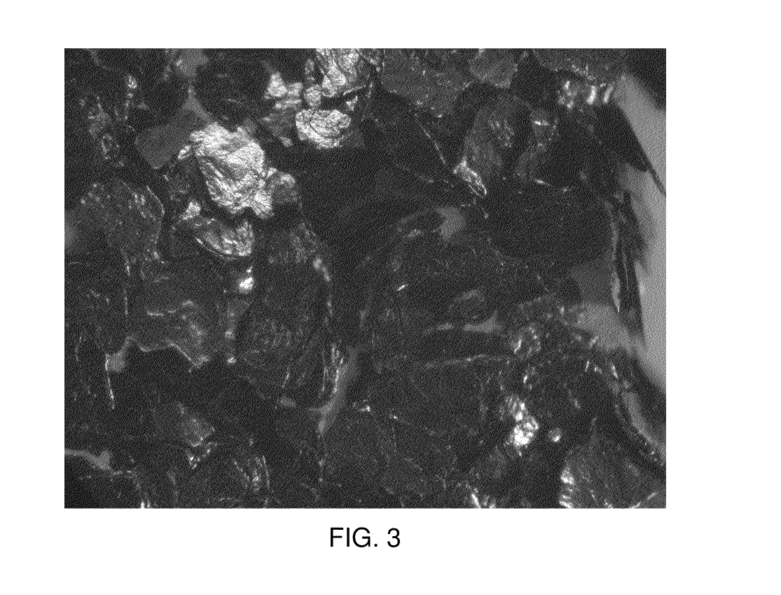

Graphite particles can be formed of any suitable type of graphite. In some embodiments, the graphite particles can comprise or be made using natural graphite. FIG. 3 includes an optical image of exemplary graphite particles, according to one set of embodiments. Natural graphite can occur in a variety of forms. In some embodiments, the natural graphite can include crystalline flake graphite (commonly referred to as flake graphite). Generally, flake graphite occurs as isolated, flat, plate-like particles, with hexagonal edges if unbroken, and potentially irregular or angular edges when broken. In addition, natural graphite can comprise lump graphite (also referred to as vein graphite) which can occur in fissure veins or fractures and appears as massive platy intergrowths of fibrous or acicular crystalline aggregates.

In some cases, the graphite particles can comprise or be made using synthetic graphite. Examples of synthetic graphite include, for example, Highly Ordered Pyrolytic Graphite (HOPG), electrographite, and the like. In some embodiments, the graphite particles can comprise or be formed from a combination of two or more types of graphite.

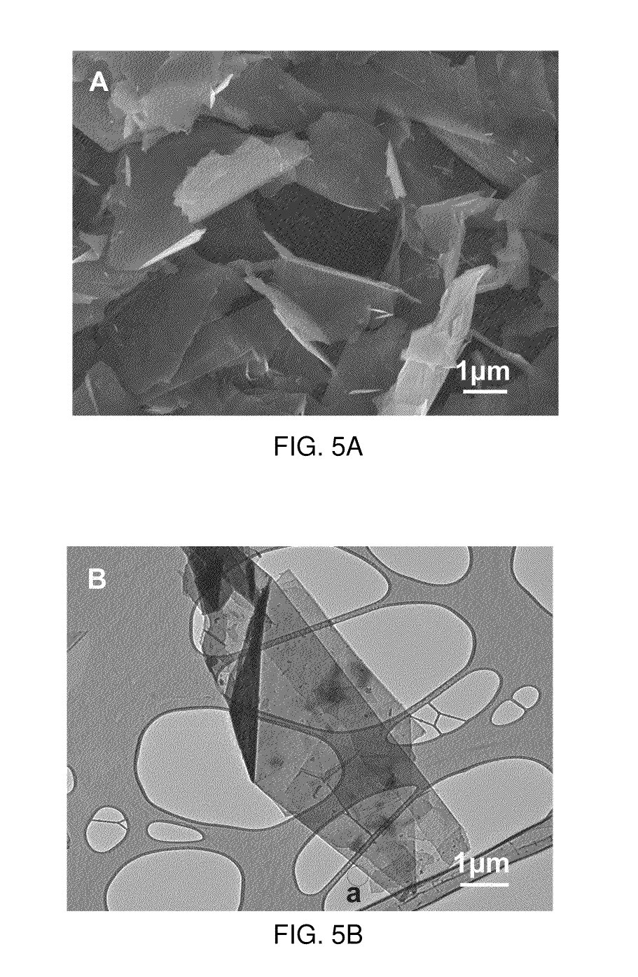

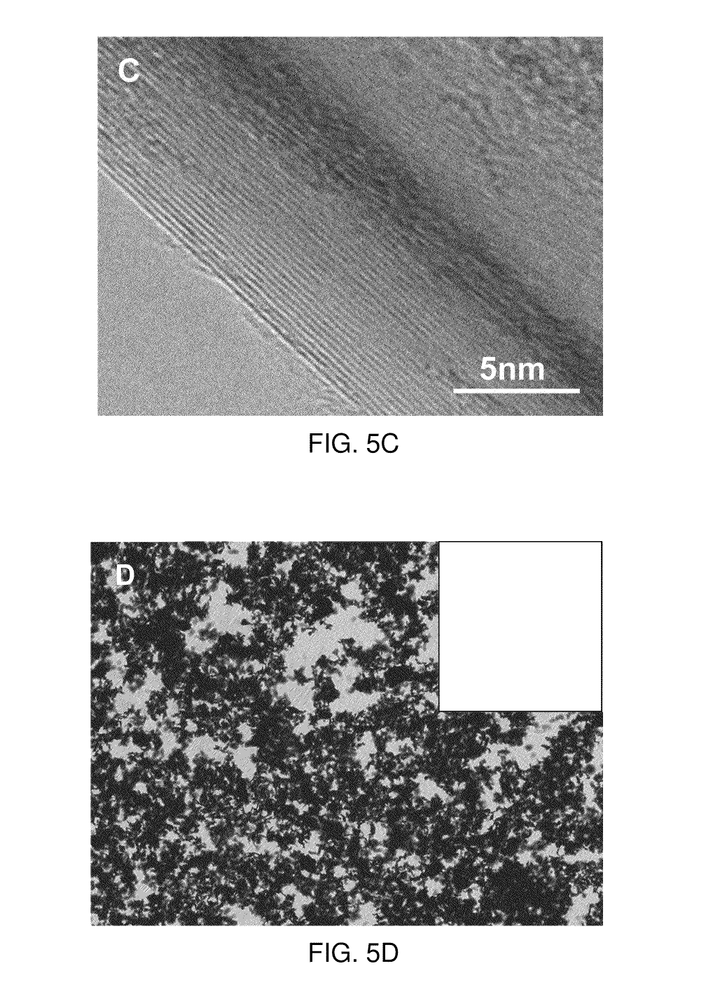

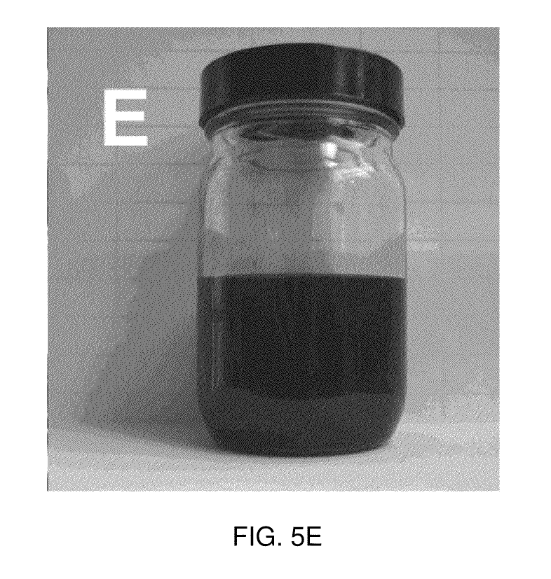

The graphite particles can comprise, in some embodiments, exfoliated graphite. FIG. 5A includes an exemplary scanning electron micrograph of exfoliated graphite, according to one set of embodiments. Methods for the production of exfoliated graphite are described below. In some embodiments, the exfoliated graphite may occupy a volume at least about 10 times, at least about 50 times, at least about 100 times, at least about 300 times, or at least about 500 times the volume of the graphite particles (e.g., graphite flakes) from which it is formed. Accordingly, the density of the exfoliated graphite particles may be at least about 10 times, at least about 50 times, at least about 100 times, at least about 300 times, or at least about 500 times less than the density of the graphite particles (e.g., graphite flakes) from which they are formed.

The graphite particles described herein can include a relatively high amount of carbon (e.g., at least about 95 wt %, at least 99 wt %, or at least 99.9 wt %), the carbon percentage measured exclusive of any functional groups that might be attached to the particles. In some cases, the graphite particles may contain one or more impurities (e.g., metals, dopants) within or between their carbon lattices (e.g., as in the case of intercalated graphite). An example of an intercalated graphite particle can include, for example, potassium graphite (KC₈), calcium graphite (CaC₈), and the like. Intercalated graphite can be capable of exhibiting superconductivity (i.e., essentially zero electrical resistance).

The use of graphite can be particularly beneficial when low viscosity suspensions are desired. Graphite can act as a superlubricant. Superlubricity is a phenomenon known in the art, and generally refers to an effect wherein the friction between two surfaces approaches, but does not reach, zero. The use of superlubricants such as graphite can be useful in maintaining a relatively low amount of friction within the suspensions described herein. The use of low-friction fluids can allow for effective circulation using a relatively low amount of pumping power and can reduce the amount of surface damage to moving parts within a piece of equipment. In addition, low-friction, high-conductivity fluids may be useful in dual-purpose applications that require effective lubrication and high heat and/or electricity transfer. Not wishing to be bound by any theory, the superlubricity of graphite may arise from the relatively low attractive forces (e.g., van der Waals forces) between the layers of graphene within the graphite.

In some embodiments, the particles can have at least one microscale (or smaller) dimension. The choice of particle dimension can be important in forming a stable suspension. For example, particles with microscale dimensions can be relatively easy to suspend in a fluid relative to particles with millimeter-scale or larger dimensions. In addition, fluids containing microscale particles are less likely to block a conduit in a heat exchanger system, compared to systems that employ particles with millimeter-scale or larger dimensions.

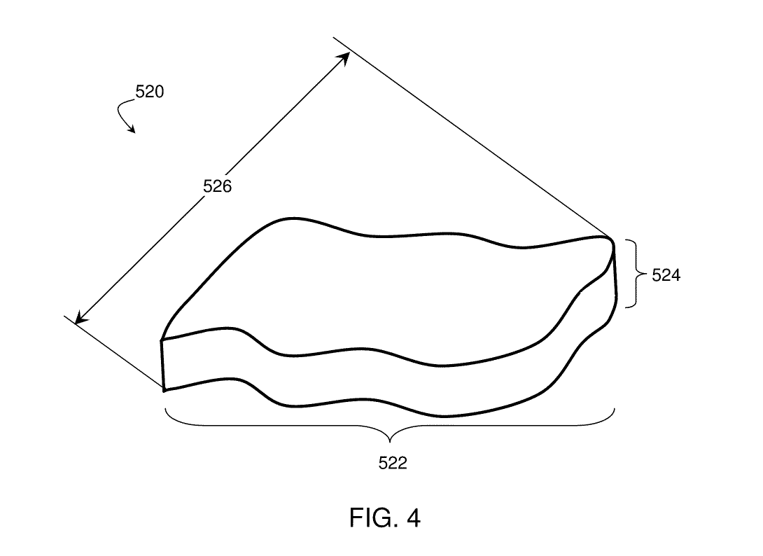

In some cases, a majority of the particles have maximum cross-sectional dimensions of less than about 10 microns. As used herein, the “maximum cross-sectional dimension” refers to the largest distance between two boundaries of an individual structure that may be measured. For example, in FIG. 4, particle 520 has a width 522 and a thickness 524. The maximum cross sectional dimension of the graphite particle is indicated by dimension 526. The “average maximum cross-sectional dimension” of a plurality of particles refers to the number average of the maximum cross-sectional dimensions of those particles. One of ordinary skill in the art would be capable of determining the maximum cross-sectional dimension of a particle by analyzing scanning electron micrograph (SEM) images of the particle. In some embodiments, a majority of the particles have maximum cross-sectional dimensions of less than about 1 micron, less than about 100 nanometers, between about 1 nanometer and about 10 microns, between about 10 nanometers and about 10 microns, between about 1 nanometer and about 1 micron, between about 10 nanometers and about 1 micron, or between about 1 nanometer and about 100 nanometers.

A relatively high percentage of the particles in a suspension can, in some cases, have microscale (or smaller) dimensions. For example, in some embodiments, at least about 80%, at least about 90%, at least about 95%, or at least about 99% of the particles within the suspension have maximum cross-sectional dimensions of less than about 10 microns, less than about 1 micron, less than about 100 nanometers, between about 1 nanometer and about 10 microns, between about 10 nanometers and about 10 microns, between about 1 nanometer and about 1 micron, between about 10 nanometers and about 1 micron, or between about 1 nanometer and about 100 nanometers.

In some embodiments, the particles can have a relatively high aspect ratio. For example, the particles can comprise flakes in some instances. Generally, flakes are characterized as having a thickness substantially smaller than the lateral dimensions of the flake. In some embodiments, the particles can comprise elongated structures such as microtubes, microwires, microfilaments, microcones, nanotubes, nanowires, nanodisks, nanosheets, nanofilaments, nanocones, and the like. Such structures are characterized as having an average thickness substantially smaller than the length of the structure. In some embodiments, a majority, at least about 80%, at least about 90%, at least about 95%, or at least about 99% of the particles can include two orthogonal dimensions having an aspect ratio of at least about 3:1, at least about 5:1, at least about 10:1, at least about 50:1, at least about 100:1, at least about 500:1, at least about 1000:1, or at least about 10,000:1.

The particles can have relatively high thermal conductivities in at least one direction, in some embodiments. In some cases, the particles can be made of a material having a thermal conductivity, in at least one direction, of at least about 10 W/mK, at least about 50 W/mK, at least about 100 W/mK, at least about 500 W/mK, at least about 1000 W/mK, or at least about 5000 W/mK, as measured at 25° C. The particles can, in some embodiments, be made of a material having a thermal conductivity, in at least one direction, that is at least about 5 times, at least about 10 times, at least about 100 times, at least about 1000 times, at least about 10,000 times, at least about 20,000 times, between about 5 times and about 20,000 times, between about 10 times and about 20,000 times, between about 100 times and about 20,000 times, or between about 1000 times and about 20,000 times larger than the thermal conductivity of the fluid in the suspension medium, as measured at 25° C.

In some instances, the particles can have relatively high electrical conductivities in at least one direction. For example, in some cases, the particles are formed of a material having an electrical conductivity, in at least one direction, of at least about 100 S m⁻¹, at least about 1000 S m⁻¹, at least about 1×10⁴ S m⁻¹, at least about 1×10⁵ S m⁻¹, or at least about 1×10⁶ S m⁻¹, as measured at 25° C. In some instances, the particles can be made of a material having an electrical conductivity, in at least one direction, that is at least about 5 times, at least about 10 times, at least about 1000 times, at least about 10⁶ times, at least about 10¹² times, at least about 10¹⁶ times, between about 10 times and about 10¹⁶ times, between about 1000 times and about 10¹⁶ times, or between about 10⁶ times and about 10¹⁶ times larger than the electrical conductivity of the fluid in the suspension medium, as measured at 25° C.

The particles described herein may, in some cases, be capable of conducting heat and/or electricity more efficiently in a first direction (and/or more directions, e.g., an in-plane direction in the case of a flake) relative to a second direction (e.g., a second direction substantially perpendicular to the first direction). Such particles are said to be anisotropic conductors. The first direction in which the heat and/or electricity is more efficiently conducted may be along the length of the particle (e.g., in a direction substantially parallel to the plane of a graphene sheet). The second direction in which the heat and/or electricity is less efficiently conducted may be along the thickness of the particle (e.g., in a direction that intersects multiple graphene sheets). In some embodiments, the particle dimension along the first direction is longer than the particle dimension along the second direction, and the particle is said to have high in-plane conductivity. Examples of anisotropic conductors include, for example, graphene sheets, graphite particles, carbon nanotubes, carbon nanowires, and the like.

The particles can have, in some cases, a relatively low electrical conductivity but a relatively high thermal conductivity. For example, the particles can comprise SiC (e.g., SiC nanoparticles, SiC nanofibers). The particles may comprise, in some embodiments, boron nitride. In some cases, the particles can comprise a polymer (e.g., polymer fibers). For example, the particles can comprise electrically insulating polymer materials with relatively high thermal conductivities.

Any suitable fluid (e.g., liquid, gel) may be used to form the suspension media described herein. In some cases, the suspension medium can include a hydrogel. A hydrogel is a material comprising a polymer network that is able to trap and contain water. The hydrogel may comprise polymer chains that are crosslinked, either directly or via a crosslinking agent. The degree of crosslinking may be varied, in some cases, to tailor the extent to which the gel absorbs or retains fluids. Examples of polymers capable of forming hydrogels include, silicon-containing polymers, polyacrylamides, crosslinked polymers (e.g., polyethylene oxide, polyAMPS and polyvinylpyrrolidone), polyvinyl alcohol, acrylate polymers (e.g., sodium polyacrylate), and copolymers with an abundance of hydrophilic groups.

In some embodiments, the suspension medium is a solid (e.g., a polycrystalline solid). Such suspension media can be formed by freezing a fluid. If polycrystalline solids are desired, one can freeze a fluid capable of forming a polycrystalline solids. One of ordinary skill in the art would be able to identify the types of fluids that are capable of forming polycrystalline solids upon freezing, and would be capable of screening for such fluids by, for example, freezing a sample of the fluid and performing an appropriate crystallographic analysis. One of ordinary skill in the art would be capable of determining whether a polycrystalline solid has been formed by using, for example, x-ray diffraction (XRD) techniques.

The suspension medium can contain include any suitable component (regardless of phase). For example, the suspension medium can include organic or inorganic components. Examples of components that can be used in the suspension medium include, but are not limited to, water, alcohols (e.g., ethylene glycol, ethanol), hydrocarbons (e.g., hexadecane, eicosane, triacontane, dodecane, decane, undecane, icosane, octadecane, pentadecane) or a combination of these. The suspension medium can contain, in some cases, a hydrophilic fluid (e.g., water, alcohols, etc.). In some embodiments, the suspension can contain a hydrophobic fluid (e.g., hydrocarbons, etc.). Generally, the terms hydrophilic and hydrophobic are used to refer to a fluid's ability to form a stable mixture with water without the use of a surfactant or other entity that stabilizes the interaction between the fluid and the water. Relatively high melting point components can be included in the suspension medium, in some embodiments. For example, in some cases, the suspension medium can include a metal. For example, the fluid can include a solder which can contain, for example, tin, copper, silver, bismuth, indium, zinc, antimony, lead, and/or a combination of any of these. In some cases, it is also possible to use other fluids. The selection of the fluid type may depend on the application in which the suspension is used.

In some embodiments, a component of the suspension medium may be selected based at least in part upon the freezing point and/or melting point of the component (accounting for cases where the freezing and melting points of the component are different). For example, a component of the suspension medium may be selected such that its freezing point and/or melting point falls within a specific range of temperatures (e.g., between about −120° C. and about 200° C.). In some cases, a component of the suspension medium may be selected such that its freezing point and/or melting point are relatively close to room temperature or lower. Such suspension media may be useful in applications that employ devices that are sensitive to high temperature. In some cases, a component of the suspension medium may be selected such that its freezing point and/or melting point falls between about −120° C. and about 40° C., between about −20° C. and about 40° C., between about −5° C. and about 40° C., between about 0° C. and about 35° C., between about 15° C. and about 25° C., etc.). The ability to select a component of the suspension medium based upon freezing point and/or melting point can allow one to tailor the suspension such that the phase transition (and hence, variation in thermal and/or electrical conductivity) occurs at a temperature suitable for the particular application in which the suspension is to be used. For example, water can be used as a component of the suspension medium in sensor applications requiring the detection of when the temperature of an object falls below or exceeds 0° C. As another example, hexadecane, which has a melting point of about 18° C., can be used in sensors for operation closer to room temperature.

The suspensions described herein may include any suitable concentration of particles. In some embodiments, the suspensions may include a particle concentration of below about 2 vol %, below about 1 vol %, between about 0.01 vol % and about 2 vol %, between about 0.05 vol % and about 2 vol %, between about 0.1 vol % and about 2 vol %, between about 0.5 vol % and about 1 vol %, between about 0.6 vol % and about 0.9 vol %, or between about 0.7 vol % and about 0.85 vol %. In some embodiments, it is also possible to produce suspensions including particle concentrations outside the ranges described above. One of ordinary skill in the art would be capable of calculating the volume percentage of particles in a suspension. For example, to make such a calculation, the mass of the particles can be measured. The volume of the particles can then be calculated by dividing the measured mass by the density of the particles. The volume percentage can then be calculated by dividing the volume of the particles by the sum of the volume of the particles and the volume of the suspension medium.

In some embodiments, an electrical potential may be applied across the suspension (e.g., in the liquid form, the solid form, or both). This may be useful, for example when using the suspension as part of a thermistor. In some embodiments, a suspension may be used as a temperature sensor. In some such embodiments, an electrical potential may be applied across a liquid suspension with a relatively low electrical conductivity. If the suspension is frozen due to exposure to relatively low temperatures, a solid composite with a relatively high electrical conductivity can be formed. The relatively high electrical conductivity of the solid can allow electrical current to be passed through the suspension, allowing for the actuation of, for example, a climate control system. Of course, one of ordinary skill in the art would recognize that a temperature sensor could also comprise a solid composite that melts upon exposure to sufficiently high temperatures, thus cutting off the flow of electrical current. As another example, a suspension can be used as an electrical fuse. In some such embodiments, an electrical potential can be applied across the solid composite with a relatively high electrical conductivity, causing an electrical current to flow through the solid composite. If the electrical current exceeds a threshold level, the solid composite may melt, for example, due to resistive heating (i.e., Joule heating) of the solid composite. Upon melting, the solid composite may form a liquid suspension with a relatively low electrical conductivity. The relatively low electrical conductivity of the liquid suspension may cause a substantial decrease in (or a cutoff of) the electrical current that passes through the suspension, thereby serving as a fuse.

In some cases, a thermal gradient may be applied across the suspension (e.g., the liquid suspension, the solid composite, or both). For example, a thermal gradient may be applied across a solid composite with a relatively high thermal conductivity, causing heat to flow through the solid composite. If the temperature of the solid composite exceeds a threshold level, it may melt, resulting in the formation of a liquid suspension with a relatively low thermal conductivity. The relatively low thermal conductivity of the liquid suspension may cause a substantial decrease in the amount of heat transported through the suspension, which may, for example, protect temperature sensitive devices downstream of the suspension.

The suspensions described herein can be used to control the transfer of electricity and/or heat in multiple locations, in some embodiments. For example, in some cases, a liquid suspension can be transported to a first location and frozen to promote the flow of electricity and/or heat at the first location. In some cases, the solid composite can be re-melted, transported to a second location, and re-frozen to promote the flow of electricity and/or heat at the second location. Additional transport steps may be performed to promote the flow of electricity and/or heat at third, fourth, fifth, or any number of additional locations. Transport between locations can be achieved, for example, by applying a pressure gradient to the suspension (e.g., using a vacuum, pump, or any other suitable device).

The suspensions described herein can be formed using any suitable method. In some embodiments, the suspension may be formed by combining a plurality of particles with a fluid (e.g., by adding the particles to the fluid or by adding the fluid to the particles).

In some cases, the particles described herein can be functionalized such that they include functional groups. Functionalization of particles may enhance the stability of the suspension of particles, or it may allow for the stable suspension of particles that would otherwise form unstable suspensions. For example, relatively hydrophobic particles can be functionalized such that their surfaces become relatively hydrophilic, allowing for stable suspension within a hydrophilic fluid such as water and alcohols. In addition, relatively hydrophilic particles can be functionalized such that their surfaces become relatively hydrophobic. The surface of the particles can be functionalized to include a wide variety of functional groups such as, for example, hydroxyl groups, carbonyl groups, epoxy groups, and the like.

In some cases, the particles are capable of forming a stable suspension within the fluid in the absence of functional groups on the surfaces of the particles. In some embodiments, the particles are capable of forming a stable suspension within the fluid in the absence of a surfactant. In some cases, the particles are capable of forming a stable suspension within the fluid in the absence of all stabilizing agents. A “stabilizing agent,” as used herein, refers to any entity that increases the stability of a suspension of particles relative to the stability that would be present in the absence of the stabilizing agent, but under essentially identical conditions (i.e., temperature, pressure, etc.). Exemplary stabilizing agents include, for example, surfactants, acids, alkaline materials, stabilizing functional groups attached to the particles (e.g., phenyl groups or carboxylic groups), and the like.

The suspensions described herein may comprise a stable suspension of particles, in some cases. For example, in some embodiments, the particles can remain stably suspended within the fluidic suspension medium for at least about 1 day, at least about 1 week, at least about 1 month, at least about 6 months, or at least about 1 year. Generally, a stable suspension is one in which substantially no settling of the particles occurs over the time period of use. Systems and methods of forming stable suspensions of graphite particles are described, for example, in U.S. patent application Ser. No. 12/638,135, filed Dec. 15, 2009, entitled “Graphite Microfluids,” which is incorporated herein by reference in its entirety.

The systems and methods described herein may provide one or more advantages relative to traditional thermistors and other temperature and/or electrical control systems. For example, the fabrication of suspension-based devices is relatively fast and inexpensive, compared to similar electronics-based systems. In addition, the suspension-based systems can be operated at or around room temperature, and changing the temperature of operation can be achieved by simply replacing a component of the suspension medium. The suspension-based systems can also be easily transported from one location to another within a temperature or electrical control system via pumping or other fluidic control schemes.

The following example is intended to illustrate certain embodiments of the present invention, but does not exemplify the full scope of the invention.

### Example

This example describes the tuning of electrical and thermal properties of materials via phase transition. Using a graphite-hexadecane suspension, the electrical conductivity of the material can be changed by two-orders-of-magnitude, and the thermal conductivity can be changed by a factor of three at a temperature of about 18° C.

The suspensions tested in this example included exfoliated graphite flakes suspended in n-hexadecane (99.5+%, Sigma Aldrich). First, exfoliated graphite was prepared from natural graphite (Asbury Graphite Mills, Inc., NJ, USA) using a chemical intercalation and thermal expansion method, as presented in Tryba et. al., Carbon 43 (2005), pp 2397-2429. The intercalation process used an oxidative agent including 85 ml H₂SO₄ (96%, Alfa Aesar) and 15 ml Hydrogen peroxide (30%, Alfa Aesar). In the intercalation process, 2.2 g of natural graphite was reacted with 100 ml of the oxidative agent at room temperature for 60 min. Subsequently, the slurries were rinsed with dionized water to remove residual salts and acids. The rinsed slurries were then filtered and baked on a hotplate at 110° C. for 24 hours to produce graphite intercalation compounds. Expanded graphite was obtained by thermally expanding the as-prepared graphite intercalation compounds in a 1100 W commercial microwave oven for 30 s. The expanded graphite was then dispersed in n-hexadecane to create a 1 vol % graphite suspension. To produce graphite flakes, the suspensions of expanded graphite were directly exfoliated by ultrasonication using a high intensity ultrasonic processor (Sonics VC750, 750 W, 80% amplitude) for 15 min. This resulted in the production of a uniform dispersion. 0.2 vol %, 0.4 vol %, 0.6 vol %, and 0.8 vol % suspensions were prepared by further addition of n-hexadecane, and an additional 3 minute ultrasonication step. Upon cooling to room temperature, stable suspensions were formed.

XPS analysis indicated that the surface of graphite flakes contained about 8% oxygen atoms. Not wishing to be bound by any theory, this may have originated from hydroxyl, epoxide, and carboxyl groups on the graphite surface.

The morphologies of the expanded graphite and the exfoliated graphite flakes were observed using a scanning electron microscope (SEM) (JEOL JSM-6320). The microstructure of the exfoliated graphite was observed using a transmission electron microscope (TEM) (JEOL 200cx, JEOL 2011) at room temperature. The graphite flakes had an average in-plane diameter of several micrometers, and average thicknesses from several to several tens of nanometers. FIG. 5A includes an exemplary SEM image of graphite flakes made via the H₂SO₄ intercalation, microwave expansion, and ultrasonic exfoliation processes described above. Most of the graphite flakes were non-planar, and some of them formed rolls (FIG. 5B). This may have been due to the inner stress induced in the course of preparation. FIG. 5C includes an HRTEM image of the selected area “a” in FIG. 5B. It was found that the flakes included about thirty layers with average interplanar distances of about 0.335 nm, consistent with those observed in graphite. FIG. 5D includes an optical microscope image of a 0.2% (V/V) graphite/hexadecane suspension. From this image, it can be observed that the graphite flakes formed a 3-dimensional percolated network. The fuzzy regions in the optical microscope image were caused by the over focus or under focus of non-coplanar graphite flakes. The formation of the percolation network indicated the formation of a thickened graphite/hexadecane suspension. FIG. 5E includes a photo of a 50 ml sample of 0.2% v/v graphite/hexadecane suspension three months after formation. It was observed that the suspension was very stable, as substantially no sediment was observed in the suspension.

The electrical resistance of the graphite suspensions was measured by pouring the graphite suspension into a self-made conductivity cell which has two dipping parallel vertical cooper electrodes with an area of about 1.17 cm², spaced about 4.85 cm apart. The system resistance of the conductivity cell was about 0.8 ohms. The electrical conductivity of the graphite suspensions was calculated as:

$$Λ = \frac{k}{R} \qquad [ 1 ]$$

where R is the measured resistance, and k=3.83 cm⁻¹ is the cell constant.

The thermal conductivity of the graphite suspensions was measured using the transient hot-wire method developed by Nagasaka and Nagashima (J. Phys. E: Sci. Instrum. 14, 1435 (1981)). A 50-micron diameter Pt wire with a 25 micron-thick insulating adhesion layer was fully immersed in the samples. The wire was subjected to a current pulse of precisely known amplitude, and the resulting temperature rise was determined as a function of time by monitoring changes in the electrical resistance of the wire. By analyzing the temporal temperature profile using solutions to the heat conduction equation, the thermal conductivity of each sample was determined.

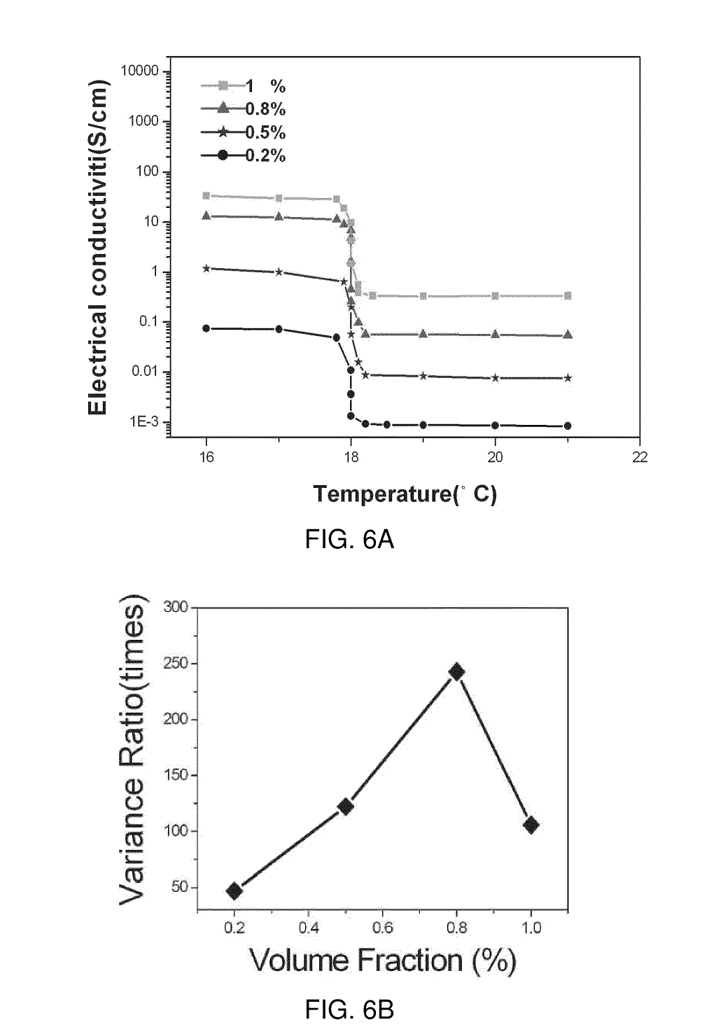

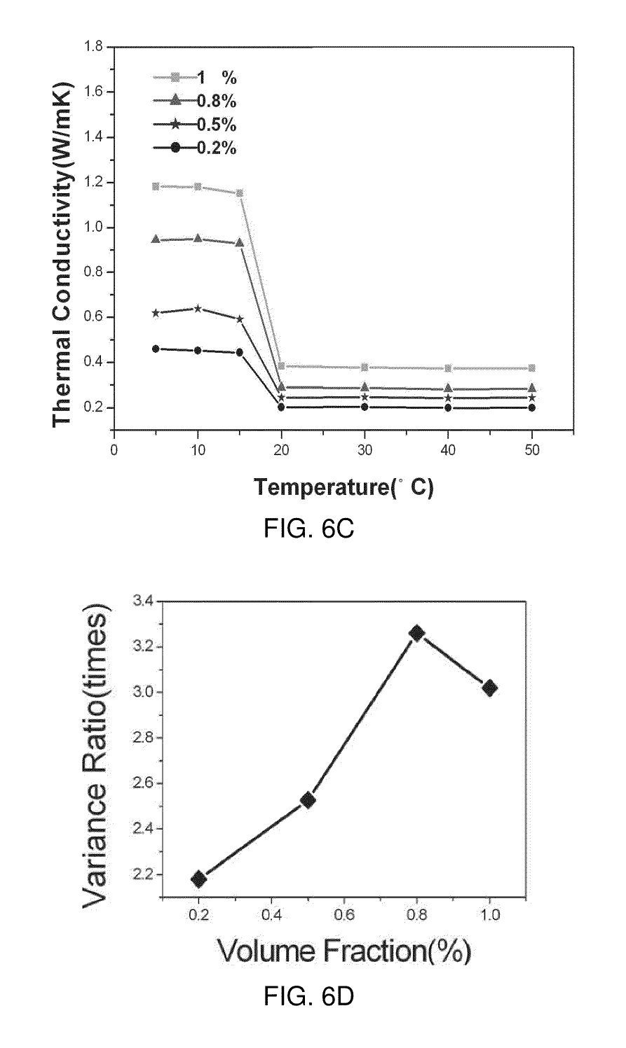

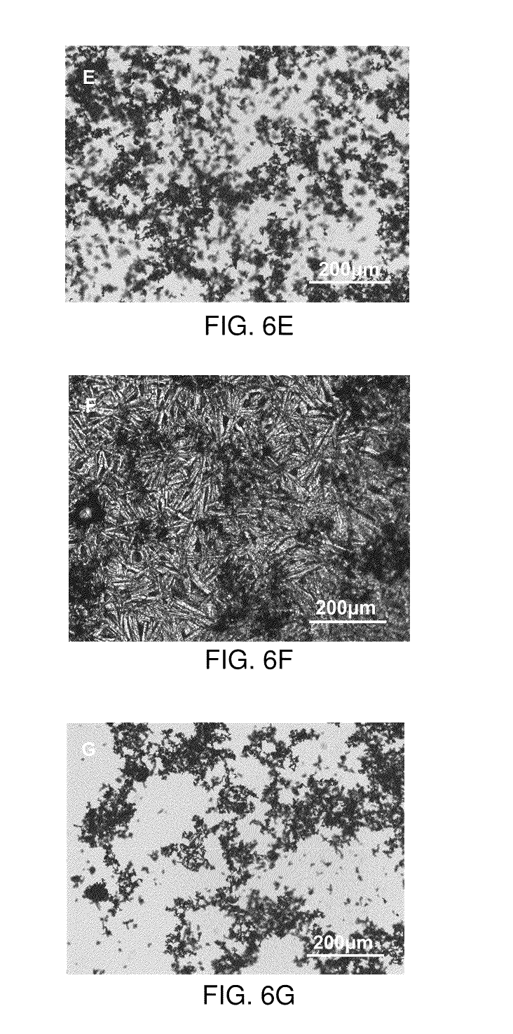

The electrical and thermal conductivities of graphite suspensions varied significantly at about 18° C. FIG. 6A includes a plot of electrical conductivity of the graphite suspensions as a function of temperature. In the liquid state, the electrical conductivity of the graphite suspensions varied little with a change in temperature. At temperatures between about 17.5° C. and about 18.5° C., the electrical conductivity increased about two orders of magnitude. After the hexadecane was frozen, the electrical conductivity stabilized. In both the solid or the liquid states, the electrical conductivity increased with an increase in graphite loading. However, as indicated in FIG. 6B, the ratio of the electrical conductivity of the frozen suspension to the electrical conductivity of the liquid suspension (which illustrates the increase in the electrical conductivity upon freezing) peaked at about 250 times at a volume fraction of about 0.8%.

As shown in FIG. 6C, the thermal conductivities of the graphite suspensions also increased upon freezing. At a volume fraction loading of 0.8%, the thermal conductivity of the suspension increased about 3.2 times upon freezing (FIG. 6D).

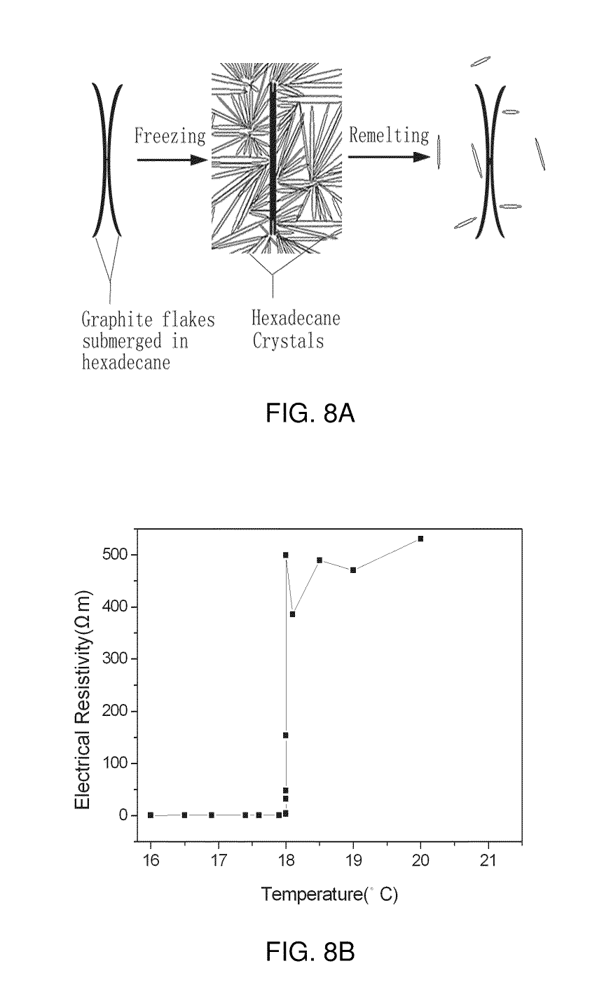

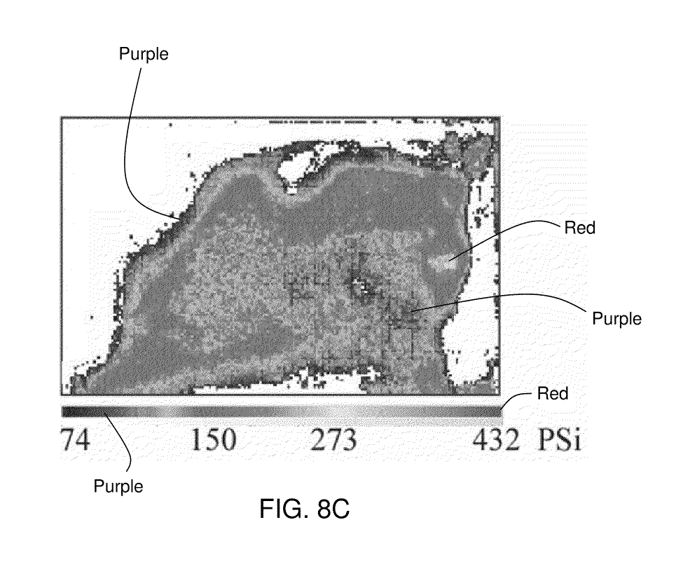

In order to obtain a sharp image of microstructure evolution of the graphite/hexadecane suspension in the course of freezing and melting, a dilute suspension (0.05% graphite/hexadecane) was used. In the liquid state, the graphite flakes were relatively evenly distributed in hexadecane. In some cases, parts of the graphite flakes were attracted to each other, forming graphite clusters. In FIG. 6E, the black areas correspond to the graphite clusters while the hexadecane grains are shown as needle-like structure. In the course of freezing, the graphite flakes were pushed to the crystal grain boundaries by the anisotropic growth of needle-like hexadecane crystals, generating a three-dimensional percolation network (FIG. 8F). As the frozen hexadecane was re-melted, the graphite percolation network remained substantially intact, and a few free suspended graphite flakes could be observed (FIG. 8G).

The change in electrical and thermal conductivity of graphite the suspensions appeared to be related to the evolution of the microstructure. When frozen for the first time, most of graphite flakes were pushed to the grain boundary, forming a close contacting percolation network that increased the contact areas of graphite flakes and reduced the thermal and electrical contact resistance. When the frozen hexadecane was re-melted, the contact area between the graphite flakes decreased quickly, and the electrical and thermal conductivities sharply decreased. However, many graphite flakes were trapped in the percolation network, and relatively few graphite flakes were suspended in the melted liquid. The electrical conductivity of the re-melted suspension was two times larger, compared to the original suspension. After the first temperature cycle, the percolation structure became more stable, and the ratio of the electrical and thermal conductivities in the frozen and re-melted states approached a constant.

The electrical and thermal conductivity variance of the graphite suspension appeared to be related to the density of graphite clusters. When the graphite flakes were transported to the grain boundaries, clusters were formed by the growth of hexadecane crystals. At low graphite volume fractions, many of the clusters were isolated. With an increase in graphite volume fraction, more and more graphite clusters were connected, increasing the ratio of the conductivities (both electrical and thermal) between liquid and solid states, as indicated in FIGS. 6B and 6D. As the graphite volume fraction was increased further, the graphite clusters became well connected in the liquid state. As the more concentrated graphite suspensions were frozen, the electrical and thermal conductivities varied less. Furthermore, the grain size of hexadecane was reduced with an increase in graphite loading, which decreased the pressure induced by anisotropic growth of hexadecane crystals. As a result, the highest changes in electrical and thermal conductivity between the liquid and solid states were observed at a graphite volume fraction of 0.8%.

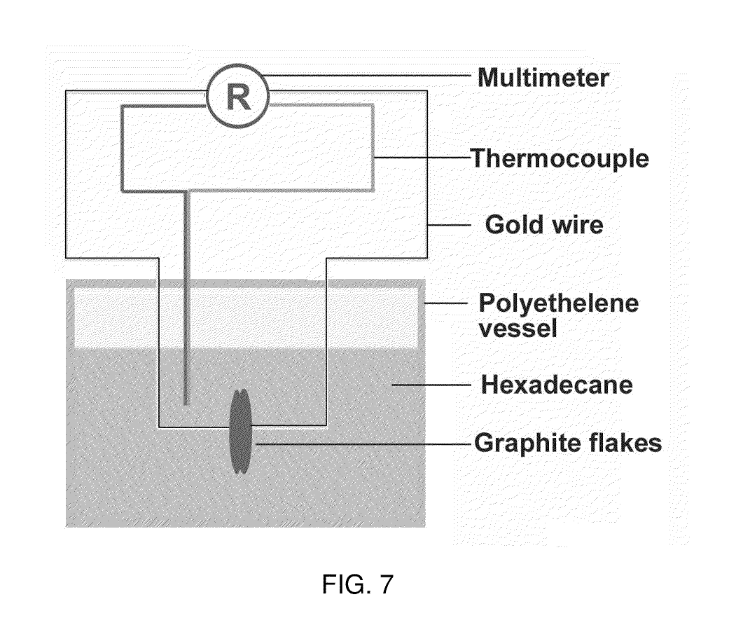

FIG. 7 includes an experimental room temperature setup used to measure the contact resistance between two peeled HOPG graphite flakes in a hexadecane environment. A polyethylene vessel including liquid hexadecane was used as a container. Two graphite flakes were immersed in hexadecane and each was connected to a multimeter by 30 micron diameter gold wire. Graphite flakes were peeled from Highly Ordered Pyrolytic Graphite (HOPG SPI-1, SPI Supplies Inc.). The dimension of the graphite flakes was about 1 micron×3 mm×3 mm. The graphite flakes were contacted by adjusting the gold wires. Temperature and resistance were measured by a multi-meter. The inner pressure of hexadecane was measured by super low pressure indicating films (Pressurex, Sensor Products Inc.), and the data was analyzed by Topaq software (Sensor Products Inc.) The natural peeled HOPG graphite flakes were uneven and curved. When they approached each other, the contact area was small and, therefore, the electrical resistance between flakes was high. Hexadecane exhibited strong anisotropic growth kinetics, varying over ten times with crystallographic orientation. During the freezing of hexadecane, the hexadecane formed needle-like crystals, with an aspect ratio that depended on the freezing speed. Not wishing to be bound by any particular theory, the anisotropic growth of the hexadecane crystals may have generated pressure on the surface of graphite flakes, rapidly increasing their contact area. After frozen, the contact area and electrical resistance tended to stabilize. Upon re-melting the hexadecane, the pressure on graphite flakes was released and the contact area was quickly reduced due to the elastic recovery of graphite flakes and inter-particle repulsion (FIG. 8A). As the temperature decreased from 18.5° C. to 17.5° C., the resistivity of the circuit decreased about 460 times, as shown in FIG. 8B. FIG. 8C includes a stress distribution map in frozen hexdecane. The pressure was unevenly distributed, between about 74 psi and about 400 psi. The average pressure within the frozen hexadecane suspension was about 160 psi. Not wishing to be bound by any particular theory, the non-uniform pressure distribution may have been due to the anisotropic growth of the hexadecane crystals. The bending rigidity of the graphite flakes was only about 9×10⁻¹¹ N m², leading to a variation in resistance between graphite flakes of more than 400 times under an average pressure of 160 psi.

What is claimed is:

1. A method, comprising:
providing a fluid comprising particles; and
freezing the fluid to form a polycrystalline solid comprising crystal grains and grain boundaries, wherein
a majority of the particles have maximum cross-sectional dimensions of less than about 10 microns,
the particles have a thermal conductivity of at least about 5 W/mK and/or an electrical conductivity of at least about 10 S m⁻¹, in at least one direction, as measured at 25° C., and
during the freezing step, at least a portion of the particles within the fluid migrate toward regions in which grain boundaries are formed such that the concentration of the particles at the grain boundaries is greater than the concentration of the particles within the crystal grains.

2. The method of claim 1, wherein, upon freezing the suspension medium, the particles form a network.

3. The method of claim 2, wherein the particles form an interconnected network.

4. The method of claim 1, wherein the particles comprise a material having an electrical conductivity and/or thermal conductivity that is at least about 5 times larger in at least one direction than the electrical conductivity and/or thermal conductivity of the fluid.

5. The method of claim 1, wherein the particles comprise nanotubes, nanodisks, nanosheets, nanowires, or nanofilaments.

6. The method of claim 1, wherein the particles comprise carbon-based particles.

7. The method of claim 1, wherein the particles comprise graphite flakes, carbon nanotubes, carbon nanowires, or carbon nanofilaments.

8. The method of claim 1, wherein the particles comprise a metal.

9. The method of claim 1, wherein the particles comprise metal nanowires, metal nanofibers, metal nanodisks, metal nanoflakes or metal nanoparticles.

10. The method of claim 1, wherein the particles comprise a metal oxide.

11. The method of claim 1, wherein a majority of the particles have aspect ratios of at least about 3:1.

12. The method of claim 1, wherein the fluid comprises water.

13. The method of claim 1, wherein the fluid comprises an organic liquid.

14. The method of claim 1, wherein the fluid comprises an alcohol.

15. The method of claim 1, wherein the fluid comprises a hydrocarbon.

16. The method of claim 1, wherein the fluid comprises hexadecane, eicosane, triacontane, dodecane, decane, undecane, icosane, octadecane, or pentadecane.

17. The method of claim 1, wherein the fluid comprises a hydrogel.

18. The method of claim 1, wherein the fluid comprises a metal.

19. A method, comprising:
providing a suspension comprising a suspension medium in a first phase and particles within the suspension medium;
applying a thermal gradient and/or an electrical potential across the suspension; and
allowing the suspension medium to undergo a phase change from the first phase to a second phase such that the thermal conductivity and/or the electrical conductivity of the suspension changes.

20. The method of claim 19, wherein a majority of the particles have maximum cross-sectional dimensions of less than about 10 microns.

21. The method of claim 19, wherein the particles have a thermal conductivity of at least about 5 W/mK and/or an electrical conductivity of at least about 10 S m⁻¹, in at least one direction, as measured at 25° C.

22. The method of claim 19, wherein the suspension is part of a thermistor.

23. The method of claim 19, wherein the suspension is part of a temperature sensor.

24. The method of claim 19, wherein the suspension is part of an electrical fuse.

25. The method of claim 19, wherein the phase change is caused by resistive heating of the suspension.

26. The method of claim 19, wherein, after a phase change, the thermal conductivity of the suspension changes by at least a factor of 2.

27. The method of claim 19, wherein, after a phase change, the electrical conductivity of the suspension changes by at least a factor of 10.

28. The method of claim 19, wherein the suspension undergoes at least 2 freeze/thaw cycles.

29. The method of claim 19, wherein the change in thermal and/or electrical conductivity between the suspensions comprising the first phase and the second phase varies by less than about 20% over at least 5 freeze/thaw cycles.

30. The method of claim 19, wherein a component of the suspension medium is selected, at least in part, based on the melting point and/or freezing point of the component.

31. The method of claim 19, wherein a component of the suspension medium has a freezing point and/or melting point between about −120° C. and about 200° C.

32. The method of claim 19, wherein the suspension comprises a liquid suspension, and the phase change comprises freezing.

33. The method of claim 19, wherein the suspension comprises a solid composite, and the phase change comprises melting.
